(19) United States
(12) Patent Application Publication
(10) Pub. No.: US 2012/0315241 A1
(43) Pub. Date: Dec. 13, 2012

(54) Bait Composition Useful For The Control Of Silverfish

(75) Inventors: Steven R. Sims, Maryland Heights, MO (US); David H. Naffziger, Chesterfield, MO (US)

(73) Assignee: BASF CORPORATION, Florham Park, NJ (US)

(21) Appl. No.: 13/495,508

(22) Filed: Jun. 13, 2012

Related U.S. Application Data
(60) Provisional application No. 61/496,325, filed on Jun. 13, 2011.

(51) Int. Cl. A01N 43/36; A01P 7/00; A01P 19/00

(52) U.S. Cl. 424/84

(57) ABSTRACT

Ready-to-use granular bait compositions that contain a feeding attractant and an active ingredient are disclosed. Methods for controlling silverfish using such bait compositions are also provided.

### CROSS-REFERENCE TO RELATED APPLICATION

The present application claims the benefit of U.S. Provisional Patent Application Ser. No. 61/496,325 filed on Jun. 13, 2011, the entire disclosure of which is expressly incorporated by reference herein.

### BACKGROUND OF THE DISCLOSURE

The field of the disclosure relates to bait compositions and, more particularly, granular bait compositions effective in controlling silverfish. The field of the disclosure also relates to methods of using the compositions for controlling silverfish.

Insects and other pests can have negative effects on the quality of human life. For instance, when found in the home, insects can be a source of annoyance due purely to their presence. They may also contaminate food, damage paper goods, and stain clothing. Additionally, when found on plants and crops, insects and other pests can destroy foliage and fruit, and may adversely affect plant and crop growth, quality, and yield.

Among the insects which are particularly undesirable are silverfish (Thysanura: Zygentoma). Silverfish species are well known as a nuisance pest inside homes or buildings, particularly in more humid environments such as in showers and in damp basements. Some female silverfish can lay more than 40 eggs at one time, and the maximum lifespan of some species can exceed six years. Silverfish will feed on almost any human food and also starch, glue, sizing, and many other carbohydrate- or protein-containing materials. They cause millions of dollars of damage each year in libraries, museums, and residences. Silverfish infestation can be an annoying and costly long-term problem in many households.

A broad range of bait compounds have been found to be toxic to insects and pests, and compositions containing these compounds may be used for their control. However, silverfish have been found to be difficult to control using bait compositions.

Thus, there is a continuing need for new compositions, products and methods that can be used to control silverfish. In many instances, proper treatment includes application of such compositions to the exterior perimeter of structures to ensure consumption by silverfish of the bait compositions entering and exiting the structure. In such exterior applications, a homeowner or pest control professional may apply the bait composition to an exterior surface of the structure, such as near the base of an exterior wall, and/or on the ground surface near the structure and/or on other exterior surfaces such as roofs and piles of cellulose-based debris (e.g., landscape timber or wood piles).

There is a also a continuing need for compositions and associated application methods that enable compositions for attracting and controlling silverfish to be applied in targeted areas accessible to silverfish within the interior of a building structure, home, and the like. For example, the compounds may be desirably applied in damp, dark areas including attics, basements, and in storage areas and closets.

### SUMMARY OF THE DISCLOSURE

In one aspect of the present disclosure, a bait composition for controlling silverfish includes a grain matrix and chlorfenapyr. The composition may further include a solvent for dissolving the chlorfenapyr prior to mixing the chlorfenapyr with the grain matrix and a sugar for increasing the consumption of the bait composition.

Another aspect of the present disclosure includes a method for controlling silverfish including applying in an area accessible to silverfish an insecticidally effective amount of a composition. The composition includes a grain matrix and chlorfenapyr.

Yet another aspect of the present disclosure is directed to a method for controlling silverfish including applying in an area accessible to silverfish an insecticidally effective amount of a composition. The composition includes an oat bran matrix and chlorfenapyr.

Various refinements exist of the features noted in relation to the above-mentioned aspects of the present disclosure. Further features may also be incorporated in the above-mentioned aspects of the present disclosure as well. These refinements and additional features may exist individually or in any combination.

### BRIEF DESCRIPTION OF THE DRAWINGS

FIG. 1 depicts a top view of a bait station for use with the bait composition of the present disclosure.

FIG. 2 depicts a side view of a bait station for use with the bait composition of the present disclosure.

FIG. 3 depicts the mortality results of silverfish after exposure to various bait compositions as analyzed in Example 2.

FIG. 4 depicts the average consumption of grain matrix by firebrats during a 21-day period as analyzed in Example 4.

Corresponding reference characters indicate corresponding parts throughout the drawings.

### DETAILED DESCRIPTION OF THE DISCLOSURE

Among the provisions of the present disclosure are bait compositions, bait stations and methods for controlling silverfish. It has been found that in embodiments of the present disclosure, a toxic chemical (e.g., chlorfenapyr) may generally be dissolved and mixed with a grain matrix to form a bait composition. In certain embodiments, the composition is in granular form and the granules are applied indoors or outdoors where evidence of silverfish has been noted (e.g., living silverfish or characteristic silverfish damage). Once applied within an area accessible to silverfish, the composition allows for more effective control of the silverfish.

### Bait Composition

In one embodiment of the present disclosure, a consumable bait composition is provided. Typically, the bait composition is a ready-to-use granular bait composition. For purposes of the present disclosure, “ready-to-use” refers to bait compositions that are not in a concentrate form but rather which may be applied without modification of the relative amounts of components within the product. The bait composition includes at least one attractive bait component being a grain matrix. Further, the composition includes an active ingredient.

### Grain Matrix

The bait composition includes a grain matrix as a bait component to aid in stimulating the consumption of the composition by silverfish, and other targeted pests. Silverfish are particularly attracted to carbohydrates such as sugar and starches. Accordingly, the grain matrix is suitably derived from cereal grains such as oat, wheat, barley, corn, safflower, soy, and combinations thereof. In one particularly suitable embodiment, the grain matrix is an oat bran matrix. One commercially available oat bran matrix for use in the bait composition includes Diamond Brand Fine Oat Bran (#12), available from La Crosse Milling Company (Cochrane, Wis.).

Suitably, the bait composition includes the grain matrix in an amount of from about 70% by weight to about 95% by weight of the composition, including from about 70% by weight to about 90% by weight of the composition, and including from about 75% by weight to about 85% by weight of the composition. In one particularly suitable embodiment, the bait composition includes a grain matrix in an amount of about 80% by weight.

### Active Ingredient

The active ingredient within the grain matrix of the bait composition is chlorfenapyr. Chlorfenapyr (4-bromo-2-(4-chlorophenyl)-1-ethoxymethyl-5-trifluoromethyl-1H-pyrrole-3-carbonitrile) is a pro-insecticide derived from halogenated pyrroles. As used herein, the term “pro-insecticide” refers to any compound or substrate that is metabolized into an active insecticide only after ingestion by a host. Particularly, when chlorfenapyr is consumed by an insect or pest, such as a silverfish, it is oxidized to form CL 303268, which uncouples oxidative phosphorylation in the mitochondria, resulting in disruption of ATP, cellular death, and ultimately mortality. While chlorfenapyr has been previously used on ornamental crops against pests such as mites, caterpillars, thrips, and fungus gnats, it has now been unexpectedly found to be particularly effective against silverfish. Chlorfenapyr is commercially available from BASF Corporation (St. Louis, Mo.).

Suitably, chlorfenapyr is present in the bait composition in an amount of from about 0.05% by weight to about 1.0% by weight of the composition, including from about 0.10% by weight to about 0.50% by weight of the composition, and including from about 0.15% by weight to about 0.35% by weight of the composition. In one particularly suitable embodiment, the bait composition includes chlorfenapyr in an amount of about 0.20% by weight.

### Optional Components

In certain embodiments, chlorfenapyr is first dissolved using a suitable solvent prior to being introduced into the grain matrix of the bait composition. The use of a solvent allows for uniform dispersion of the chlorfenapyr within the grain matrix. Solvents suitable for use in the bait composition to dissolve chlorfenapyr typically include, for example, water; alcohols such as methanol, ethanol, isopropyl alcohol (2-propanol), n-propanol (1-propanol), butanols (isobutanol, n-butanol, sec-butanol, tert-butanol), pentanols, hexanols, and the like and derivatives thereof; glycols such as ethylhexyl glycerin, 1,2-octanediol (caprylyl glycol), 1,2-propanediol, 1,3-propanediol, 1,2-butanediol, 1,3-butanediol, 1,4-butanediol, 2,3-butanediol, polyethylene glycol (PEG), and the like and derivatives thereof; and glycerin. In preferred embodiments, a polar carrier solvent is selected from among water, glycerin, ethylhexyl glycerin, 1,2-octanediol (caprylyl glycol), 1,2-propanediol, 1,2-butanediol, 1,3-butanediol, 1,4-butanediol, 2,3-butanediol, polyethylene glycol (PEG), ethanol, and isopropyl alcohol (2-propanol). One particularly suitable solvent includes Pluriol E 3350, a PEG available from BASF Corporation (Florham Park, N.J.).

When used, the solvent is present in the bait composition in an amount sufficient to dissolve the chlorfenapyr, including amounts ranging from about 1.0% by weight to about 20% by weight of the composition, including from about 5% by weight to about 15% by weight, and including from about 7% by weight to about 13% by weight. In one particularly suitable embodiment, the bait composition includes about 10% by weight of a solvent.

In some embodiments, the bait composition further comprises a sugar. Generally, sugars are utilized to increase the attractiveness of the composition to the silverfish. Particularly, it has been found that silverfish consume significantly more bait composition when the composition includes one or more sugars. Generally, a natural or synthetic mono-, di-, or polysaccharide may be used as a sugar. Among suitable sugars are sucrose, fructose, glucose, mannose, galactose, maltodextrose, molasses, and mixtures thereof. Suitably, the sugars can be used in liquid or powder form. In one embodiment, the sugar is powdered confectionary sucrose. The composition may include at least 0.5% sugar by weight and, in another embodiment, at least 1.0% sugar by weight. In various embodiments, the bait composition includes from about 1.0% by weight to about 20% by weight sugar, including from about 5.0% by weight to about 15% by weight sugar, and including about 10% by weight sugar. The composition may include more than one sugar with the total amount of sugar corresponding to the previously listed amounts.

Another component that may be included in the bait composition as an attractant is salt. For example, sodium chloride may be included in the bait composition in an amount of from about 2% by weight to about 5% by weight of the composition to increase consumption of the composition by silverfish. While sodium chloride is provided as an exemplary salt, it should be understood by one skilled in the art that any salt known in the art suitable for use in a bait composition may be used herein without departing from the scope of the present disclosure.

Generally, the bait composition is prepared by mixing all ingredients in their relative proportions. In one embodiment, as noted above, the chlorfenapyr is first dissolved in a solvent. For example, in one particularly suitable embodiment, the solvent is heated to a temperature of approximately 80° C. and then mixed with chlorfenapyr for a period to sufficiently dissolve the chlorfenapyr within the solvent. Once dissolved, the solution of chlorfenapyr and solvent is mixed with the grain matrix and then finally mixed with any remaining ingredients, as done in Example 1 below. The mixing of the solution of chlorfenapyr and solvent with the grain matrix and other ingredients may be conducted at room temperature. Once mixed, the composition may be used as is, or added to a suitable application container.

Generally, the bait composition may be applied in a targeted space, void, crevice or surface or broadly applied in a general area accessible to silverfish. As applied, the composition may be in granular form.

In certain embodiments, the bait composition may be applied manually in the targeted space, void, crevice or surface. For example, the composition may be manually applied in interior surfaces and areas such as attics, basements, and storage areas. Additionally, the composition may be manually applied to exterior/outdoor surfaces such as wood piles, shake shingle roofing, and other cellulose-based materials.

Typically, when applied to an exterior/outdoor area, the bait composition is applied in the space, void, crevice, or surface in an amount of from about 1.5 ounces to about 8.0 ounces of composition per 100 square feet, including from about 1.75 ounces to about 6.0 ounces of composition per 100 square feet, and including from about 2.0 ounces to about 4.0 ounces per 100 square feet.

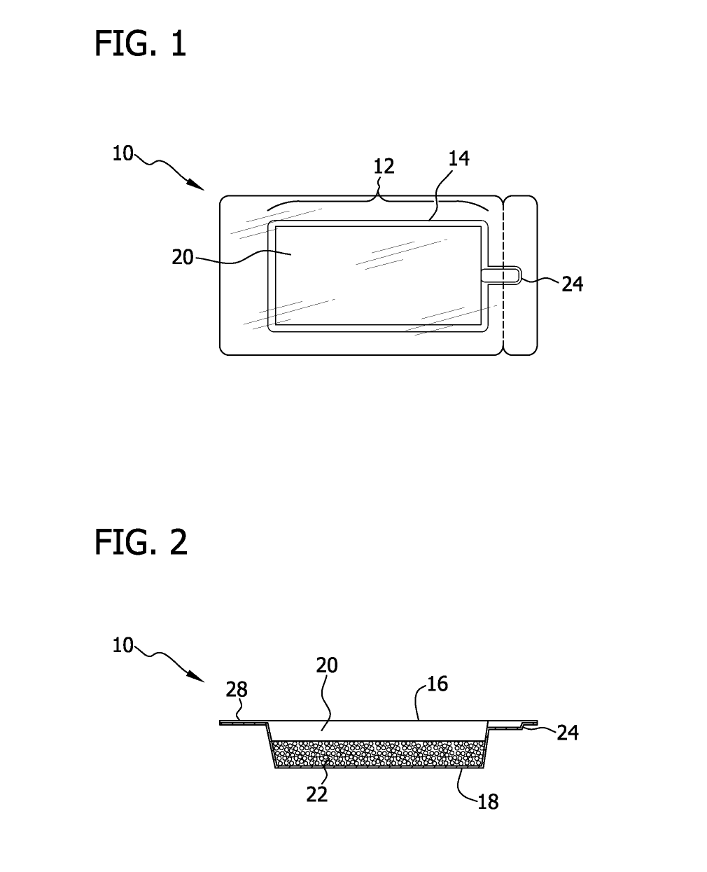

In further alternative embodiments, the bait composition may be located within a housing (i.e., bait station, generally indicated at 10). In one embodiment, as best illustrated in FIGS. 1 and 2, the station 10 comprises a substantially hollow housing 12 having a side wall 14, a top surface 16 and a bottom surface 18 defining an interior space 20 of the housing 12. A portion of the top surface 16 of the housing 12 is open for loading and accessing the bait composition 22 within the interior space 20 of the housing 12. A cap 28 is configured for removable securement to the top surface 16 to generally close the housing 12 against removal of the bait composition 22 therefrom.

Although shown as having a generally rectangular shape, the housing 12 may be any other suitable shape, such as cylindrical. As one example of suitable dimensions of the station housing 12, the station may be sized to be 5 cm×8 cm×1 cm in size or smaller. It is understood, though that the size of the station housing 12 may be larger or smaller than as set forth above.

Typically, the housing includes the composition in an amount of from about 0.5 ounces to about 8.0 ounces of composition, including from about 0.75 ounces to about 6.0 ounces of composition, and including from about 1.5 ounces to about 4.0 ounces.

### Methods for Controlling Silverfish

In one embodiment of the present disclosure, a method for controlling silverfish includes applying an insecticidally effective amount of a composition comprising a grain matrix and chlorfenapyr as described above in an area accessible to silverfish. As used herein, the term “insecticidally effective amount” refers to an amount of composition sufficient to kill at least 50%, including at least 60%, including at least 70%, including at least 80%, including at least 90%, including at least 95%, and even killing 100% of silverfish in a desired area. Other optional additives include solvents and/or sugars as described above.

The composition may be applied to a targeted surface (void, space, crevice, area, etc.) and the composition may be in a granular or powder form during application. The composition is well suited for application to the interior of commercial or residential structures and in some embodiments for application exterior of such structures as well. For example, in one embodiment of a method for controlling silverfish, the composition is manually applied to a targeted surface, such as along the walls of the floor of a basement.

In another embodiment, the composition is in a powdered form and can be applied to a targeted surface using a pressurized aerosol can device. In this embodiment, the composition may further include a propellant such as commonly used in aerosol can devices. For example, the propellant may be in the form of a liquefied gas having a boiling point of from −50° C. to 0° C., examples of which include, liquefied petroleum gas, dimethylether, propane, n-butane and isobutene. It should be recognized, however, that while the above propellants have been provided, any propellant suitable for use in bait compositions may be used without departing from the scope of the present disclosure.

When used, the propellant is typically included in the bait composition in an amount of from about 15% by weight to about 75% by weight of the composition, including from about 20% by weight to about 70% by weight of the composition, and including from about 25% by weight to about 60% by weight of the composition.

In another embodiment, the bait composition may be in a gel-type form and applied to the targeted area in such a manner as to dry to a deposit that would be attractive to silverfish. Any suitable gel-forming materials known in the art may be included in the bait composition.

In embodiments wherein the bait composition is toxic to silverfish, perimeter application ensures that silverfish which consume the bait composition are killed before entry into the structure.

While compositions, applicators and methods of embodiments of the present disclosure are generally described with reference to chlorfenapyr, it should be understood that these embodiments may optionally include additional other active ingredients in combination this compound.

### EXAMPLES

### Example 1

### Preparation of a Granular Bait Composition

Chlorfenapyr, available from BASF Corporation (St. Louis, Mo.) is weighed out into a mixing vessel. Polyethylene glycol, available as Pluriol E 3350 also from BASF, is mixed with the chlorfenapyr at a temperature of approximately 80° C. until the chlorfenapyr is completely dissolved to form a first mixture. In a separate vessel a mixture of oat bran, available from La Crosse Milling Company, Cochrane, Wis., is mixed with powdered confectionary sugar in a 9:1 weight ratio to form a second mixture. After the first mixture is completely dissolved, the first mixture is uniformly mixed with the second mixture at room temperature.

The composition produced a powder that appeared homogeneous. The relative proportions of all ingredients are shown in Table 1 below.

TABLE 1
Relative proportions of ingredients used to prepare the bait composition of
Example 1.

| Component | Inclusion (wt %) |
|---|---|
| Chlorfenapyr | 0.20 |
| Pluriol E 3350 | 10.0 |
| Powdered Confectionary Sugar | 10.0 |
| Oat Bran | 79.8 |

### Example 2

### Evaluation of the Efficacy of Two Baits to Control Silverfish

In this Example, the efficacy of bait compositions including 0.20% by weight chlorfenapyr was evaluated as compared to bait compositions not including chlorfenapyr.

Specifically, four samples of bait composition were prepared using the method of Example 1. The four samples included: (1) bait composition including 0.20% by weight chlorfenapyr combined with ground rolled oats having a granule size able to pass through a US Standard Sieve #16; (2) bait composition without chlorfenapyr comprised of ground rolled oats having a granule size able to pass through a US Standard Sieve #16; (3) bait composition including 0.20% by weight chlorfenapyr combined with an oat bran composition having a granule size able to pass through a US Standard Sieve #12; and (4) bait composition without chlorfenapyr comprised of an oat bran having a granule size able to pass through a US Standard Sieve #12.

Four test groups of silverfish of the species Lepisma saccharina (n=20), including both adults and juvenile silverfish, were housed in separate plastic shoe boxes with the inside walls coated with Fluon™ and with crumpled papers and cardboard supplied as refuges for a period of two weeks. The silverfish were fed dry oatmeal and provided access to water. After two weeks, the food was removed for 24 hours and then replaced with equal amounts of the respective bait compositions. All bait compositions were placed in the center of the test chamber beside a water source.

Visual checks were made for the number of dead silverfish in the boxes after 12 hours, 1 day, 2 days, 3 days, 5 days, 7 days, 10 days, and 14 days. Bait compositions were left in the test boxes throughout the test. Each test was replicated four times for each bait composition.

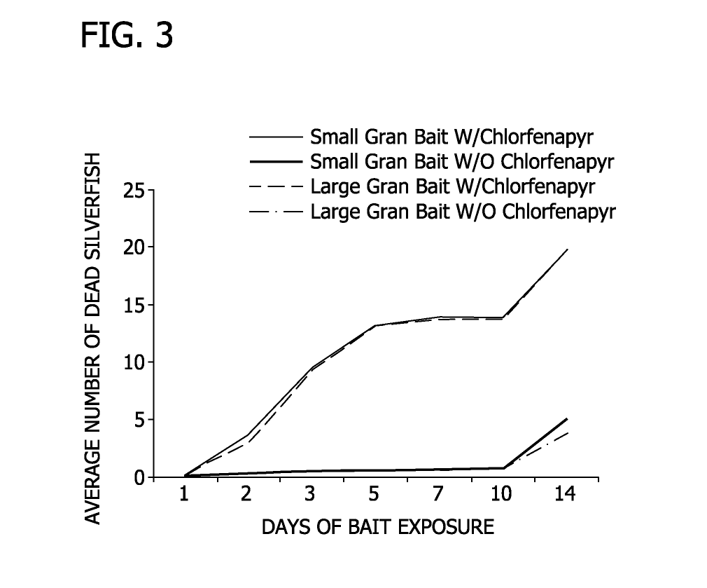

Evaluation of the results consisted of making counts of dead silverfish and comparing the counts. Table 2 and FIG. 3 show the results.

TABLE 2
Number of dead silverfish (Lepisma saccharina) exposed to bait composition containing chlorfenapyr

| | Time | | | | | | | |
|---|---|---|---|---|---|---|---|---|
| Bait Composition | 12 hours | 1 day | 2 days | 3 days | 5 days | 7 days | 10 days | 14 days |
| Sample 1: Bait | 0 | 1 | 6 | 11 | 14* | 14 | 14 | 20 |
| Composition with | | | | | | | | |
| chlorfenapyr (Test 1) | | | | | | | | |
| Sample 1: Bait | 0 | 0 | 4 | 7 | 12* | 12 | 12 | 20 |
| Composition with | | | | | | | | |
| chlorfenapyr (Test 2) | | | | | | | | |
| Sample 1: Bait | 0 | 0 | 3 | 12 | 15 | 16 | 16 | 19 |
| Composition with | | | | | | | | |
| chlorfenapyr (Test 3) | | | | | | | | |
| Sample 1: Bait | 0 | 0 | 2 | 8 | 12 | 14* | 14 | 20 |
| Composition with | | | | | | | | |
| chlorfenapyr (Test 4) | | | | | | | | |
| Sample 2: Bait | 0 | 0 | 1 | 1 | 1 | 1 | 1 | 4 |
| Composition without | | | | | | | | |
| chlorfenapyr (Test 1) | | | | | | | | |
| Sample 2: Bait | 0 | 0 | 0 | 0 | 0 | 0 | 0 | 6 |
| Composition without | | | | | | | | |
| chlorfenapyr (Test 2) | | | | | | | | |
| Sample 2: Bait | 0 | 0 | 0 | 0 | 0 | 0 | 1 | 6 |
| Composition without | | | | | | | | |
| chlorfenapyr (Test 3) | | | | | | | | |
| Sample 2: Bait | 0 | 0 | 0 | 1 | 1 | 1 | 1 | 4 |
| Composition without | | | | | | | | |
| chlorfenapyr (Test 4) | | | | | | | | |
| Sample 3: Bait | 0 | 0 | 3 | 9 | 14* | 14 | 14 | 20 |
| Composition with | | | | | | | | |
| chlorfenapyr (Test 1) | | | | | | | | |
| Sample 3: Bait | 0 | 0 | 1 | 5 | 12 | 14* | 14 | 20 |
| Composition with | | | | | | | | |
| chlorfenapyr (Test 2) | | | | | | | | |
| Sample 3: Bait | 0 | 1 | 4 | 12* | 12 | 12 | 12 | 19 |
| Composition with | | | | | | | | |
| chlorfenapyr (Test 3) | | | | | | | | |
| Sample 3: Bait | 0 | 0 | 4 | 11 | 15* | 15 | 15 | 20 |
| Composition with | | | | | | | | |
| chlorfenapyr (Test 4) | | | | | | | | |
| Sample 4: Bait | 0 | 0 | 0 | 1 | 1 | 1 | 1 | 3 |
| Composition without | | | | | | | | |
| chlorfenapyr (Test 1) | | | | | | | | |
| Sample 4: Bait | 0 | 0 | 0 | 0 | 0 | 0 | 0 | 4 |
| Composition without | | | | | | | | |
| chlorfenapyr (Test 2) | | | | | | | | |
| Sample 4: Bait | 0 | 0 | 1 | 1 | 1 | 1 | 2 | 5 |
| Composition without | | | | | | | | |
| chlorfenapyr (Test 3) | | | | | | | | |
| Sample 4: Bait | 0 | 0 | 0 | 0 | 0 | 0 | 0 | 3 |
| Composition without | | | | | | | | |
| chlorfenapyr (Test 4) | | | | | | | | |

*represents the likely time that all individuals in this trial had been eliminated even though some individuals had not been accounted for at the time of that specific check.

As illustrated in FIG. 3, comparisons of mortality between the bait compositions including chlorfenapyr and control bait compositions without chlorfenapyr show that the treatment with chlorfenapyr resulted in much higher mortality than was found in the control replications (P<0.001). Further, there was no significant difference in bait consumption among compositions of different granule size.

### Example 3

### Evaluation of Candidate Active Ingredients for Insecticidal Bait Compositions Against the Silverfish, Lepisma saccharina L

In this Example, two active ingredients were formulated to determine their potential as bait compositions against silverfish.

Specifically, four bait compositions were prepared by mixing rolled oats with or without an active ingredient in the following concentrations: (1) 0.05% (wt/wt) chlorfenapyr; (2) 0.20% (wt/wt) chlorfenapyr; (3) 5.0% (wt/wt) boric acid (available as NiBan-FG™, Nisus Corporation, Rockford, Tenn.); and (4) 0% (wt/wt) active ingredient (no active ingredient).

Prior to testing, silverfish were reared in approximately 15-liter plastic boxes maintained at 25° C. and supplied dry ground oats and water ad libitum. For testing, five test groups of six adult silverfish each were then placed in the bottom of a 0.473 liter plastic cup containing a 5 cm-length of wetted dental wick and 3 cm-length cylindrical cardboard harborage. Approximately 0.15 g of granular bait composition was placed in a 4.5 cm plastic weighing boat and placed in the plastic cup with the silverfish with or without competitive food (i.e., ground oatmeal). A total of five replicate cups were used for each test sample. Bait composition and competitive food consumption was determined after test day 21. Results are shown in Table 3.

TABLE 3

| | | Consumption of | | Total |
|---|---|---|---|---|
| | | Bait Composition | Consumption of | Consumption (Bait + |
| Treatment | Competitive Food | (g) | Food (g) | Food) (g) |
| Control (oatmeal) | No | 0.0578 ± 0.0032 | — | 0.0578 ± 0.0032 |
| | Yes^{a} | | | 0.0479 ± 0.0079 |
| 0.05% by weight | No | 0.0044 ± 0.0013 | — | 0.0044 ± 0.0013 |
| Chlorfenapyr | Yes | | | 0.0146 ± 0.0022 |
| 0.20% by weight | No | 0.0028 ± 0.0041 | — | 0.0028 ± 0.0041 |
| Chlorfenapyr | Yes | | | 0.0254 ± 0.0063 |
| 5.0% by weight | No | 0.0122 ± 0.0052 | — | 0.0122 ± 0.0052 |
| NiBan-FG ™ | Yes | | | 0.0976 ± 0.0530 |

^{a}Two containers of control (oatmeal).

Daily mortality of the silverfish was also recorded. Silverfish were scored dead if they did not move when touched with a metal probe. Mortality was quantified and the treatments were compared using Probit analysis (SAS Institute). Results are shown in Table 4.

TABLE 4

| | Competitive | LT₅₀ (95% confidence | | | | |
|---|---|---|---|---|---|---|
| Treatment | Food | intervals) d | Slope ± SE | n | X² | P |
| Control | No | —^{a} | — | 30 | — | — |
| (oatmeal) | | | | | | |
| Control | Yes | —^{a} | — | 30 | — | — |
| (oatmeal) | | | | | | |
| 0.05% | No | 2.56 (2.11-2.98) | 2.61 ± 0.21 | 30 | 150.72 | <0.0001 |
| chlorfenapyr | Yes | 3.97 (3.47-4.45) | 3.27 ± 0.25 | 30 | 173.67 | <0.0001 |
| 0.20% | No | 2.49 (1.92-3.03) | 2.00 ± 0.18 | 30 | 119.23 | <0.0001 |
| chlorfenapyr | Yes | 2.59 (1.74-3.37) | 2.20 ± 0.29 | 30 | 56.05 | <0.0001 |
| 5.0% boric | No | 32.72 (26.17-54.17) | 4.05 ± 0.84 | 30 | 23.45 | <0.0001 |
| acid | Yes | 40.99 (28.73-134.68) | 3.55 ± 0.99 | 30 | 12.86 | 0.0003 |

^{a}There was <5% (1 of 245 total silverfish) mortality during the 21-day study.

As shown in Tables 3 and 4, there was <5% mortality of silverfish fed the control diet of ground oatmeal during the 21-day test. Silverfish fed the oatmeal consumed 57.8 mg when it was presented in one dish and 47.9 mg when it was presented in two dishes. These values are not significantly different (P>0.05) and are consistent with previous bait composition studies.

LT₅₀ values for the bait compositions ranged from 2.49 d for the 0.20% chlorfenapyr bait composition without competitive food to 40.99 d for the 5.0% boric acid bait composition with competitive food. All bait compositions (with or without competitive food) had LT₅₀ values that were significantly different from the oatmeal control. There was no difference in LT₅₀ values between the two 0.20% chlorfenapyr treatments with and without competitive food and 5.0% boric acid bait treatments with and without competitive food; however, the LT₅₀ value for the 0.05% chlorfenapyr bait composition without competitive food was significantly lower than that for the same treatment with competitive food. The difference in LT₅₀ values (1.41 d) may not be biologically significant in field situations.

Consumption of bait compositions without competitive food ranged from 0.0028 g for the 0.20% chlorfenapyr bait composition to 0.0122 g for the 5.0% boric acid bait composition. Due to handling difficulties and the almost identical appearance of the ground oatmeal and the formulated bait compositions, it was not possible to differentiate bait and competitive food consumptions. However, since total consumption (bait composition+competitive food) was always greater when competitive food was present, it is reasonable to assume that the additional consumption was due to consumption of the ground oatmeal. Total consumption ranged between 14.6 mg for the 0.05% chlorfenapyr bait composition and 97.6 mg for the 5.0% boric acid bait composition.

In conclusion, the 0.05% and 0.20% chlorfenapyr bait compositions had the lowest LT₅₀ values (i.e., best control efficacy) against silverfish. More particularly, compared with the 5.0% boric acid bait composition, both chlorfenapyr bait compositions were clearly superior.

### Example 4

### Comparative Evaluation of Grain Matrices for Silverfish Bait Compositions

In this Example, the feeding attraction of three different grain matrices to firebrats (Thermobia domestica Packard) was evaluated.

Prior to testing, firebrats (Thermobia domestica Packard) were reared in 115-liter plastic coolers maintained in total darkness at 30° C. and supplied ground Quaker Oats™ (100% Natural Whole Grain Quaker Rolled Oats) and water ad libitum.

Grain matrices were supplied by BASF Corporation (St. Louis, Mo.) as the following: (1) 100% by weight oat bran (available from La Crosse Milling Company, Cochrane, Wis.); (2) 95% by weight oat bran and 5% by weight confectioner's sugar (available from Imperial Sugar, Sugar Land, Tex.); and (3) 90% by weight oat bran and 10% by weight confectioner's sugar.

Approximately 2.0 g of grain matrix was placed in a 6-sided 2.5″×2″ polystyrene weight dish medium and placed in the bottom of a 9″ round×2″ deep vertical walled aluminum pan. One side of the weigh dish was cut to allow the firebrats easy access. Each of the aluminum pans contained one of the three grain matrices. In addition, one 2″×2″ piece of card stock folded in half was supplied as a harborage, and one 1.5″ piece of Absorbal™ gauze covered, surgical cellulose wadding was used to supply water. The opening of each weigh dish faced the center of the pan and the positions of the weigh dishes were randomized.

Ten adult firebrats were placed in each of seven replicate pans. Three additional pans contained the grain matrices, harborage and water wick, but no firebrats, and served as evaporation controls for the treatments.

The ten total pans were placed on a table in a room controlled at 82° F. (28° C.) with a 12:12 light:dark photoperiod and covered with a screen measuring 37.5″×19.5″. Water was added to the water wick every other day. At day 21, the firebrats were removed and the treatments were re-weighed. There was <5% mortality of firebrats during the entire 21-day test.

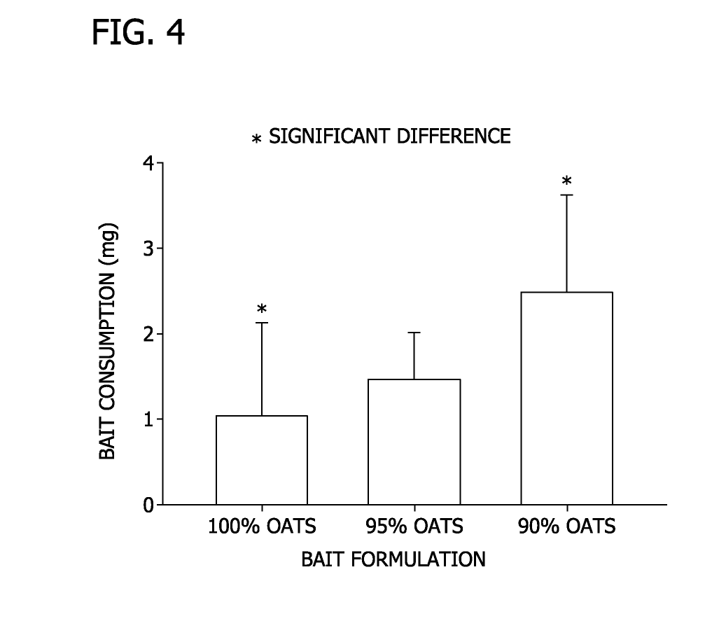

The initial weights of the treatments used in the feeding preference test were corrected based on the average change in weight of the evaporation controls of the same treatments. Average consumption of the three treatments was compared using analysis of variance (SigmaPlot12 software). The results are shown in FIG. 4.

As shown in FIG. 4, during the 21 days, the 100% oat bran matrix lost approximately 4.40% weight, the 95% oat bran grain matrix lost approximately 3.11% weight, and the 90% oat bran grain matrix lost approximately 3.22% weight. Average total treatment consumption for ten firebrats over a 21-day period was 49.9 mg.

Grain matrix consumption by ten firebrats over 21 days ranged from 10.4 mg in the 100% oat bran matrix to 24.8 mg for the 90% oat bran matrix. There was an overall significant difference in grain matrix consumption (P<0.05). The Holm-Sidak multiple comparison procedure indicated that consumption of the 90% by weight oat bran matrix was significantly different than that of the 100% by weight oat bran matrix. Due to the smaller number of replicates, there was no significant difference between the 95% by weight oat bran matrix and the other matrices. The trend however, is that consumption increased with decreasing amounts of oat bran and increasing amounts of sugar.

In conclusion, there was significant consumption of oat brain grain matrices by firebrats. Matrices consisting of lower amounts of oat bran and greater amounts of sugar were preferred.

### Example 5

### Evaluation of Candidate Silverfish Bait Compositions Against Several Common Stored Products Insect Pests

In this Example, the performance of several silverfish bait compositions were evaluated against several stored products insect pests.

The stored products pests included: cowpea weevil (Callosobruchus maculates (Fab.)); red flour beetle (Tribolium castaneum (Herbst)); yellow mealworm (Tenebrio molitor L.); and dermestid (Trogoderma sp.). Prior to testing, the cowpea weevils were fed dry black-eyed peas, the red flour beetles were fed ground wheat flour, the yellow mealworms were fed rolled oats, and the dermestids were fed chicken bones and meat. All species were reared in approximately 10-liter plastic containers and maintained in a photoperiod of 12:12 light:dark at 28° C.

The following bait compositions were prepared by mixing ground oats with or without an active insecticide ingredient in the following concentrations: (1) 0.01% (wt/wt) abamectin (BASF Corporation, St. Louis, Mo.); (2) 0.05% (wt/wt) abamectin (BASF Corporation, St. Louis, Mo.); (3) 0.05% (wt/wt) chlorfenapyr (BASF Corporation, St. Louis, Mo.); (4) 0.20% (wt/wt) chlorfenapyr (BASF Corporation, St. Louis, Mo.); (5) 0.001% (wt/wt) fipronil (BASF Corporation, St. Louis, Mo.); (6) 0.01% (wt/wt) fipronil (BASF Corporation, St. Louis, Mo.); (7) 0.063% (wt/wt) metaflumizone (BASF Corporation, St. Louis, Mo.); (8) 0.25% (wt/wt) metaflumizone (BASF Corporation, St. Louis, Mo.); (9) 5.0% (wt/wt) boric acid (available as NiBan-FG™, Nisus Corporation, Rockford, Tenn.); and (10) 0% (wt/wt) active ingredient, ground oatmeal only.

For testing, test groups of ten adult cowpea weevils, ten adult red flour beetles, five dermestid beetle larvae, or five larval yellow mealworms each were placed in the bottom of a 0.473 liter plastic cup. Approximately 0.15 g of granular bait composition was placed in the bottom of the plastic cup with the pests. A total of five replicate cups were used for each test sample.

Mortality was recorded every other day for 14 days. Insects were scored as dead if they did not move when touched with a metal probe. Mortality was quantified and the compositions were compared using Probit analysis (SAS Institute). Results are shown in Tables 5 and 6.

TABLE 5
Toxicity of Insecticidal Bait Compositions to Yellow Mealworms

| | LT₅₀ | | | | |
|---|---|---|---|---|---|
| Treatment | (95% confidence intervals) d | Slope ± SE | n | X² | P |
| Control (oatmeal) | —^{a} | — | 25 | — | — |
| 0.01% abamectin | 11.28 (9.57-13.78) | 3.13 ± 0.50 | 25 | 39.28 | <0.0001 |
| 0.05% abamectin | 14.36 (11.83-19.60) | 2.88 ± 0.55 | 25 | 27.34 | <0.0001 |
| 0.05% chlorfenapyr | 9.37 (7.49-10.79) | 5.54 ± 1.21 | 25 | 20.97 | <0.0001 |
| 0.20% chlorfenapyr | 4.20 (3.12-5.47) | 2.45 ± 0.37 | 25 | 43.63 | <0.0001 |
| 0.001% fipronil | 8.95 (7.71-10.26) | 4.02 ± 0.56 | 25 | 50.99 | <0.0001 |
| 0.01% fipronil | 7.75 (6.54-9.16) | 3.06 ± 0.39 | 25 | 61.28 | <0.0001 |
| 0.063% metaflumizone | 16.29 (14.31-49.01) | 8.24 ± 3.41 | 25 | 5.82 | 0.0158 |
| 0.25% metaflumizone | 46.55 (23.99-1407) | 1.88 ± 0.66 | 25 | 8.03 | 0.0046 |
| 5.0% boric acid | 421.45 (88.41-1.36E8) | 12.21 ± 4.85 | 25 | 6.33 | 0.0046 |

^{a}There was no mortality during the 14-day study.

TABLE 6
Toxicity of Insecticidal Bait Compositions to Red Flour Beetles

| | LT₅₀ | | | | |
|---|---|---|---|---|---|
| Treatment | (95% confidence intervals) d | Slope ± SE | n | X² | P |
| Control (oatmeal) | —^{a} | — | 50 | — | — |
| 0.01% abamectin | 32.16 (11.23-2.49E13) | 0.7 ± 0.33 | 50 | 4.63 | 0.0314 |
| 0.05% abamectin | 1.17 (0.29-2.10) | 0.93 ± 0.22 | 50 | 17.95 | <0.0001 |
| 0.05% chlorfenapyr | 1.42 (0.87-1.91) | 2.86 ± 0.58 | 50 | 24.30 | <0.0001 |
| 0.20% chlorfenapyr | 1.08 (0.69-1.42) | 2.71 ± 0.47 | 50 | 32.77 | <0.0001 |
| 0.001% fipronil | 1.22 (0.48-1.95) | 1.34 ± 0.27 | 50 | 24.88 | <0.0001 |
| 0.01% fipronil | 9.29 (5.45-27.67) | 0.89 ± 0.26 | 50 | 11.59 | <0.0001 |
| 0.063% metaflumizone | 10.61 (8.72-13.60) | 1.69 ± 0.20 | 50 | 70.85 | 0.0158 |
| 0.25% metaflumizone | 15.39 (12.79-21.39) | 3.24 ± 0.65 | 50 | 24.54 | <0.0001 |
| 5.0% boric acid | 15.46 (9.32-6.24E7) | 2.91 ± 1.40 | 50 | 4.33 | 0.0374 |

There was 100% mortality of cowpea weevils by day 3 in all treatments including the untreated ground oatmeal control. Oatmeal and broken grains are apparently not suitable for this cowpea weevil strain. It will apparently only feed on whole grains such as beans and nuts.

There was very little mortality of dermestid larvae in this test. After 14 days, there was an average of one dead larva in every replicate cup, including all insecticide treatments and the untreated ground oatmeal control. One out of five larvae represents 20% mortality, however, this species is known to be cannibalistic and, given the consistent and low rate of mortality, it is more likely that these larvae suffered cannibalism than succumbed to the bait compositions.

As shown in Table 5, there was 0% mortality of yellow mealworm larvae fed the untreated ground oatmeal control during the 14-day test. LT₅₀ values for the bait compositions ranged from 4.20 d for the 0.20% chlorfenapyr bait composition and 421.45 d for the 5.0% boric acid bait composition. There was no significant effect of insecticide concentration on the LT₅₀ values of bait compositions including abamectin, fipronil, or metaflumizone. There was, however, a significantly lower LT₅₀ value for 0.20% chlorfenapyr bait composition compared with the 0.05% chlorfenapyr bait composition. Although the analysis was significant (P=0.0118), the 5.0% boric acid bait composition produced an LT₅₀ value of greater than a year.

As shown in Table 6, there was 0% mortality of red flour beetles fed the untreated ground oatmeal control during the 14-day test. LT₅₀ values for the bait compositions ranged from 1.08 d for the 0.20% chlorfenapyr bait composition to 32.16 d for the 0.01% abamectin bait composition. There was no significant effect of active ingredient concentration on the LT₅₀ values of bait compositions containing chlorfenapyr or metaflumizone, but there were significant differences in toxicity between the two concentrations of abamectin and fipronil. The 0.05% composition of abamectin was more toxic than the lower 0.01% composition, indicating increased toxicity with increased concentration. With fipronil, however, the lower 0.001% composition was more toxic than the 0.01% composition, indicating some repellency or feeding deterrence at higher concentrations.

In conclusion, the 0.05% and 0.20% chlorfenapyr bait compositions had the lowest LT₅₀ values (i.e., best performance) against yellow mealworms and red flour beetles. Compared with the 5.0% boric acid bait composition, both chlorfenapyr bait compositions were clearly superior.

### Example 6

### Evaluation of Candidate Active Ingredients for Insecticidal Bait Compositions Against the Firebrat (Thermobia domestica Packard)

In this Example, the performance of two concentrations of several insecticide bait compositions was evaluated against firebrats.

Firebrats (Thermobia domestica Packard) were reared in approximately 115-liter plastic coolers maintained in total darkness at 30° C. and supplied dry baby food (Gerber, Fremont, Mich.) and water ad libitum.

The following bait compositions were prepared by mixing ground rolled oats with or without an active insecticide ingredient in the following concentrations: (1) 0.01% (wt/wt) abamectin (BASF Corporation, St. Louis, Mo.); (2) 0.05% (wt/wt) abamectin (BASF Corporation, St. Louis, Mo.); (3) 0.05% (wt/wt) chlorfenapyr (BASF Corporation, St. Louis, Mo.); (4) 0.20% (wt/wt) chlorfenapyr (BASF Corporation, St. Louis, Mo.); (5) 0.001% (wt/wt) fipronil (BASF Corporation, St. Louis, Mo.); (6) 0.01% (wt/wt) fipronil (BASF Corporation, St. Louis, Mo.); (7) 0.063% (wt/wt) metaflumizone (BASF Corporation, St. Louis, Mo.); (8) 0.25% (wt/wt) metaflumizone (BASF Corporation, St. Louis, Mo.); (9) 5.0% (wt/wt) boric acid (available as NiBran-FG™, Nisus Corporation, Rockford, Tenn.); and (10) 0% (wt/wt) active ingredient, ground oatmeal.

Testing involved using groups of ten adult firebrats, each were placed in the bottom of a 0.473 liter plastic cup. Approximately 0.15 g of granular bait composition with or without competitive food (i.e., ground oatmeal) was placed in the bottom of the plastic cup with the pests. A total of five replicate cups were used for each test sample. Bait composition and competitive food consumption was determined after 21 days. Results are shown in Table 7.

TABLE 7

| | | Consumption of | | Total |
|---|---|---|---|---|
| | | Bait Composition | Consumption of | Consumption (Bait + |
| Treatment | Competitive Food | (g) | Food (g) | Food) (g) |
| Control (oatmeal) | No | 0.0420 ± 0.0030 | — | 0.0420 ± 0.0030 |
| | Yes^{a} | | | 0.0499 ± 0.0127 |
| 0.01% abamectin | No | 0.0148 ± 0.0023 | — | 0.0148 ± 0.0023 |
| 0.05% abamectin | Yes | | — | 0.0196 ± 0.0020 |
| 0.05% Chlorfenapyr | No | 0.0043 ± 0.0010 | — | 0.0043 ± 0.0010 |
| | Yes | | | 0.0265 ± 0.0012 |
| 0.20% Chlorfenapyr | No | 0.0074 ± 0.0041 | — | 0.0074 ± 0.0015 |
| | Yes | | | 0.0210 ± 0.0015 |
| 0.001% fipronil | No | 0.0293 ± 0.0025 | — | 0.0293 ± 0.0025 |
| | Yes | | | 0.0576 ± 0.0034 |
| 0.01% fipronil | No | 0.0204 ± 0.0028 | — | 0.0204 ± 0.0028 |
| | Yes | | | 0.0618 ± 0.0032 |
| 0.063% | No | 0.0181 ± 0.0033 | — | 0.0181 ± 0.0033 |
| metaflumizone | Yes | | | 0.0358 ± 0.0046 |
| 0.25% | No | 0.0172 ± 0.0048 | — | 0.0172 ± 0.0048 |
| metaflumizone | Yes | | | 0.0336 ± 0.0044 |
| 5.0% boric acid | No | 0.00007 ± 0.0006 | — | 0.0007 ± 0.0006 |
| | Yes | | | 0.0262 ± 0.0036 |

^{a}Two containers of control food (oatmeal).

Mortality was recorded daily for 21 days. Firebrats were scored as dead if they did not move when touched with a metal probe. Mortality was quantified and the compositions were compared using Probit analysis (SAS Institute). Results are shown in Table 8.

TABLE 8
Effects of competitive food on the toxicity of insecticidal bait compositions evaluated against
firebrats in continuous exposure studies

| | | LT₅₀ (95% confidence | | | | |
|---|---|---|---|---|---|---|
| Treatment | Competitive Food | intervals) d | Slope ± SE | n | X² | P |
| Control (oatmeal) | No | —^{a} | — | 50 | — | — |
| 0.01% | No | 71.01 (45.42-172.45) | 1.81 ± 0.31 | 50 | 33.18 | <0.0001 |
| abamectin | Yes | 54.20 (38.33-103.62) | 2.18 ± 0.35 | 50 | 38.71 | <0.0001 |
| 0.05% | No | 44.81 (33.57-76.30) | 2.50 ± 0.39 | 50 | 40.09 | <0.0001 |
| abamectin | Yes | 156.75 (73.87-849.99) | 1.18 ± 0.24 | 50 | 25.04 | <0.0001 |
| 0.05% | No | 4.02 (3.53-4.50) | 2.28 ± 0.18 | 50 | 158.89 | <0.0001 |
| chlorfenapyr | Yes | 3.98 (3.45-4.52) | 2.86 ± 0.28 | 50 | 103.41 | <0.0001 |
| 0.20% | No | 2.18 (1.75-2.59) | 2.04 ± 0.20 | 50 | 100.23 | <0.0001 |
| chlorfenapyr | Yes | 3.11 (2.25-4.04) | 1.90 ± 0.36 | 50 | 27.79 | <0.0001 |
| 0.001% | No | 21.79 (17.29-31.05) | 1.30 ± 0.18 | 50 | 51.90 | <0.0001 |
| fipronil | Yes | 59.21 (40.15-119.00) | 1.53 ± 0.23 | 50 | 43.30 | <0.0001 |
| 0.01% | No | 13.81 (11.99-16.37) | 1.71 ± 0.19 | 50 | 83.72 | <0.0001 |
| fipronil | Yes | 122.71 (63.10-535.85) | 1.33 ± 0.26 | 50 | 25.77 | <0.0001 |
| 0.063% | No | 8.46 (7.65-9.29) | 3.94 ± 0.40 | 50 | 99.33 | <0.0001 |
| metaflumizone | Yes | 8.03 (7.54-8.53) | 4.21 ± 0.30 | 50 | 194.82 | <0.0001 |
| 0.25% | No | 11.01 (10.53-11.50) | 5.69 ± 0.36 | 50 | 255.43 | <0.0001 |
| metaflumizone | Yes | 6.98 (6.26-7.77) | 4.61 ± 0.60 | 50 | 59.48 | <0.0001 |
| 5.0% | No | 421.45 (88.41-1.36E8) | 1.21 ± 0.48 | 50 | 6.40 | 0.0114 |
| boric acid | Yes | 1464 (152.95-2.69E16) | 0.89 ± 0.39 | 50 | 5.27 | 0.0217 |

^{a}There was no mortality during the 21-day study.

As shown in Tables 7 and 8, there was no mortality of firebrats fed the ground oatmeal control during the 21-day test. Firebrats fed the oatmeal consumed a total of approximately 42 mg when it was presented in one dish and a total of approximately 49.9 mg when it was presented in two dishes. These values are not significantly different (P>0.05).

LT₅₀ values for the bait compositions ranged from 2.18 d for the 0.20% chlorfenapyr bait composition without competitive food to 1464 d for the 5.0% boric acid bait composition with competitive food. All bait compositions (with or without competitive food) had LT₅₀ values that were significantly different from the oatmeal control. There was also no difference in LT₅₀ values between compositions with and without competitive food, except for the two fipronil compositions and the 0.25% metaflumizone bait composition. The LT₅₀ values of the fipronil compositions presented without competitive food were significantly lower than those for the same compositions with competitive food. Interestingly, however, the LT₅₀ value for 0.25% metaflumizone bait composition presented with competitive food was significantly lower than the composition presented without competitive food.

Consumption of bait compositions ranged from 0.0007 g for the 5.0% boric acid bait composition without competitive food to 0.0181 g for the 0.063% metaflumizone bait composition without competitive food. This range of bait composition consumption is relatively small compared with the range of consumption of the ground oatmeal control. Due to handling difficulties and the almost identical appearance of the oatmeal control and most formulated bait compositions, it was not possible to differentiate bait composition and competitive food consumption. However, since total consumption (bait composition+competitive food) was always greater when competitive food was present, it is reasonable to assume that the additional consumption was due to consumption of the competitive food. Total consumption ranged between 19.6 mg for 0.01% abamectin bait composition and 61.8 mg for the 0.01% fipronil bait composition. Total consumption of both fipronil compositions was greater than the other compositions and even greater than the oatmeal control. It is possible that fipronil is a direct feeding stimulant; that fipronil exposure increases the metabolic rate of exposed firebrats resulting in increased food consumption; or that fipronil affects digestion or metabolism in a manner that requires increased food consumption to maintain energy balance.

In conclusion, the 0.05% and 0.20% chlorfenapyr bait compositions had the best (lowest LT₅₀ values) performance against firebrats. Compared with the 5.0% boric acid bait composition, both chlorfenapyr compositions were clearly superior.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above compositions and methods without departing from the scope of the disclosure, it is intended that all matter contained in the above description and shown in the accompanying figures shall be interpreted as illustrative and not in a limiting sense.

What is claimed is:

1. A bait composition comprising a grain matrix and chlorfenapyr.

2. The bait composition as set forth in claim 1 comprising from about 70% by weight to about 95% by weight grain matrix and from about 0.05% by weight to about 1.0% by weight chlorfenapyr.

3. The bait composition as set forth in claim 1 comprising about 80% by weight grain matrix and about 0.20% by weight chlorfenapyr.

4. The bait composition as set forth in claim 1 wherein the grain matrix is derived from a cereal selected from the group consisting of oat, wheat, barley, corn, safflower, soy, and combinations thereof.

5. The bait composition as set forth in claim 1 further comprising from about 1.0% by weight to about 20% by weight of a solvent.

6. The bait composition as set forth in claim 5 wherein the solvent is selected from the group consisting of water, methanol, ethanol, isopropyl alcohol, n-propanol, butanols, pentanols, hexanols, glycols, glycerin and combinations thereof.

7. The bait composition as set forth in claim 1 further comprising from about 1.0% by weight to about 20% by weight of a sugar.

8. The bait composition as set forth in claim 7 wherein the sugar is selected from the group consisting of sucrose, fructose, glucose, mannose, galactose, maltodextrose, molasses, and combinations thereof.

9. The bait composition as set forth in claim 1 wherein the composition is a granular form.

10. A method for controlling silverfish, the method comprising applying in an area accessible to silverfish an insecticidally effective amount of a composition comprising a grain matrix and chlorfenapyr.

11. The method as set forth in claim 10 comprising applying the composition in a targeted surface, space, void or crevice and wherein the composition is in granular form.

12. The method as set forth in claim 10 comprising applying from about 1.5 ounces to about 8.0 ounces of composition per 100 square feet.

13. The method as set forth in claim 10 wherein the composition is applied in a housing.

14. The method as set forth in claim 13 wherein the housing comprises from about 0.5 ounces to about 8.0 ounces of the composition.

15. The method as set forth in claim 10 wherein the composition comprises from about 70% by weight to about 95% by weight grain matrix and from about 0.05% by weight to about 1.0% by weight chlorfenapyr.

16. The method as set forth in claim 10 wherein the composition comprises about 80% by weight grain matrix and about 0.20% by weight chlorfenapyr.

17. The method as set forth in claim 10 wherein the grain matrix is derived from a cereal selected from the group consisting of oat, wheat, barley, corn, safflower, soy, and combinations thereof.

18. The method as set forth in claim 10 wherein the composition further comprises a solvent.

19. The method as set forth in claim 10 wherein the composition further comprises a sugar.

20. A method for controlling silverfish, the method comprising applying in an area accessible to silverfish an insecticidally effective amount of a composition comprising an oat bran matrix and chlorfenapyr.

21. The method as set forth in claim 20 comprising applying the composition in a targeted surface, space, void or crevice and wherein the composition is in granular form.

22. The method as set forth in claim 20 comprising applying from about 1.5 ounces to about 8.0 ounces of composition per 100 square feet.

23. The method as set forth in claim 20 wherein the composition is applied in a housing.

24. The method as set forth in claim 23 wherein the housing comprises from about 0.5 ounces to about 8.0 ounces of the composition.

25. The method as set forth in claim 20 wherein the composition comprises from about 70% by weight to about 95% by weight oat bran matrix and from about 0.05% by weight to about 1.0% by weight chlorfenapyr.

26. The method as set forth in claim 20 wherein the composition comprises about 80% by weight oat bran matrix and about 0.20% by weight chlorfenapyr.

27. The method as set forth in claim 20 wherein the composition further comprises a solvent.

28. The method as set forth in claim 20 wherein the composition further comprises a sugar.
